(19) United States
(12) Patent Application Publication
(10) Pub. No.: US 2025/0297678 A1
(43) Pub. Date: Sep. 25, 2025

(54) Control System for Operating a Drive Train of a Motor Vehicle, and Motor Vehicle

(71) Applicant: ZF Friedrichshafen AG, Friedrichshafen (DE)

(72) Inventors: Yannick Lacroix, Friedrichshafen (DE); Florian Pawlak, Eriskirch - Mariabrunn (DE); Markus Moosmann, Grünkraut (DE)

(21) Appl. No.: 19/086,870

(22) Filed: Mar. 21, 2025

(30) Foreign Application Priority Data
Mar. 22, 2024 (DE) 102024202764.2

(51) Int. Cl. F16H 63/34; F16H 59/68

(52) U.S. Cl. CPC F16H 63/3416; F16H 59/68

(57) ABSTRACT

A control system for operating a drive train of a motor vehicle includes at least one sensor, each sensor being configured to acquire a measurement signal for an assembly of the drive train and transmit an actual identification signal for the respective sensor. The control system further includes at least one control unit, each of the at least one control unit being configured to receive the actual identification signal transmitted by a respective sensor; compare the actual identification signal with a target identification signal for the respective sensor, the target identification signal being stored in the respective control unit; receive and evaluate the measurement signal from the respective sensor; and control the operation of the drive train depending on the measurement signal only when the actual identification signal corresponds to the target identification signal for the respective sensor.

### CROSS-REFERENCE TO RELATED APPLICATION

The present application is related and has right of priority to German Patent Application No. 10 2024 202 764.2 filed on Mar. 22, 2024, the entirety of which is incorporated by reference for all purposes.

### FIELD OF THE INVENTION

The invention relates generally to a control system for operating a drive train of a motor vehicle and to a motor vehicle having such a control system.

### BACKGROUND

A drive train of a motor vehicle includes a propulsion unit and a transmission, which is preferably connected between the propulsion unit and a driven end. The transmission converts rotational speeds and torques and, in this way, provides the available tractive force of the propulsion unit at the driven end. In an electric vehicle, the transmission can be a pure reduction gear unit. In a hybrid vehicle or a vehicle propelled solely by an internal combustion engine, the transmission provides multiple shiftable gears.

A motor vehicle also includes a control system in order to control the operation of the drive train in an open loop and/or a closed loop manner. In a hybrid vehicle or a vehicle propelled solely by an internal combustion engine, the control system has at least one engine control unit for the open-loop control and/or closed-loop control of the operation of the internal combustion engine, and a transmission control unit for the open-loop control and/or closed-loop control of the operation of the transmission. In a hybrid vehicle, the transmission control unit can also control the operation of an electric machine in an open loop and/or a closed loop. In a purely electrically propelled vehicle, a control unit is preferably provided for each electrically propelled axle in order to control, in an open loop and/or a closed loop, in particular, the operation of the electric machine interacting with the particular electrically propelled axle.

In an electric vehicle and in a hybrid vehicle or in a vehicle propelled solely by an internal combustion engine, the drive train can include, for example, a parking lock or a differential. The parking lock and/or the differential can be engaged and/or disengaged, depending on the operating state. The control system includes a parking lock sensor in order to detect the state of a parking lock. The control system includes a differential lock sensor in order to detect the state of a differential lock. Measurement signals acquired by the parking lock sensor and by the differential lock sensor are safety-critical for the operation of the drive train.

A sensor, such as a parking lock sensor and a differential lock sensor, acquires a measurement signal and provides this measurement signal to a control unit of the control system, which then receives and evaluates the measurement signal acquired and transmitted by the sensor, in order to control the operation of the drive train in an open loop and/or a closed loop depending on the measurement signal.

In particular, when an assembly of the drive train that includes a sensor is exchanged during servicing of the motor vehicle, a situation can arise in which the state of the control unit, in particular a software state of the control unit, is not compatible with the exchanged assembly, such that the control unit is then unable to properly process the measurement signal provided by the sensor in the exchanged assembly. When the sensor provides a safety-relevant measurement signal, this can result in an unsafe operation of the motor vehicle.

In order to avoid such states, it is known from practical experience to mechanically code control-side assemblies of a control system of a drive train of a motor vehicle. If, for example, an assembly of the drive train that includes a parking lock sensor must be replaced due to a defect, when a mechanical coding is used, a new assembly is installable in the drive train only when the new assembly has an appropriate mechanical coding. For example, mechanical coding pins of a housing of the assembly to be exchanged must be insertable into corresponding mechanical coding holes in an adjacent component onto which the component to be exchanged is intended to fastened. If this is not the case, the corresponding component cannot be installed in the drive train. Great effort is required to provide mechanical coding. There is a need to dispense with such mechanical codings and nevertheless enable a safe operation of the drive train.

DE 10 2016 215 327 A1 discloses a parking brake of a motor vehicle, which is transferable between a first state in which the parking brake provides no clamping force, and a second state in which the parking brake builds up a clamping force. A transition point defines the transition between these two states, which transition point is identified during a release operation of the parking brake.

### SUMMARY OF THE INVENTION

The problem addressed by the present invention is that of providing a new type of control system for operating a drive train of a motor vehicle and of providing a motor vehicle having such a control system.

According to the invention, the sensor is configured to transmit an actual identification signal of the sensor. The control unit is configured to receive the actual identification signal of the sensor, which has been transmitted from the sensor, and to compare the actual identification signal with a target identification signal for the sensor, which is stored in the control unit. The control unit controls, in an open loop and/or a closed loop, the operation of the drive train depending on the measurement signal received from the sensor only when the actual identification signal corresponds to the target identification signal.

According to the present invention, for the first time, a sensor of a control system of a motor vehicle drive train also transmits, in addition to the measurement signal acquired from the sensor, an actual identification signal to a control unit. The control unit compares the actual identification signal of the sensor with a stored target identification signal for the sensor, and controls, in an open loop or a closed loop, the operation of the drive train depending on the signal received from the sensor only when the actual identification signal corresponds to the target identification signal. Thus, a digital coding is provided, which makes a mechanical coding unnecessary.

Preferably, the sensor transmits the measurement signal on a first channel, in particular on a fast channel, and transmits the actual identification signal on a second channel, in particular on a slow channel, in particular using a Single Edge Nibble Transmission protocol. Such sensors are particularly suitable for providing the digital coding.

Preferably, the sensor is a parking lock sensor, which monitors whether a parking lock is engaged or disengaged. Additionally, or alternatively, one of the sensors is a differential lock sensor, which monitors whether a differential lock is engaged or disengaged. Alternatively, or additionally, one of the sensors is a sensor which monitors whether a clutch is engaged or disengaged. All these sensors are sensors which provide safety-critical measurement signals. The invention is therefore particularly advantageously used for such sensors.

### BRIEF DESCRIPTION OF THE DRAWINGS

Preferred developments can be found in the dependent claims and in the following description. Exemplary embodiments of the invention are explained in greater detail with reference to the drawing, without being limited thereto. Wherein:

FIG. 1 shows a diagram of a first example drive train of a motor vehicle according to the invention,

FIG. 2 shows a diagram of a second example drive train of a motor vehicle according to the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

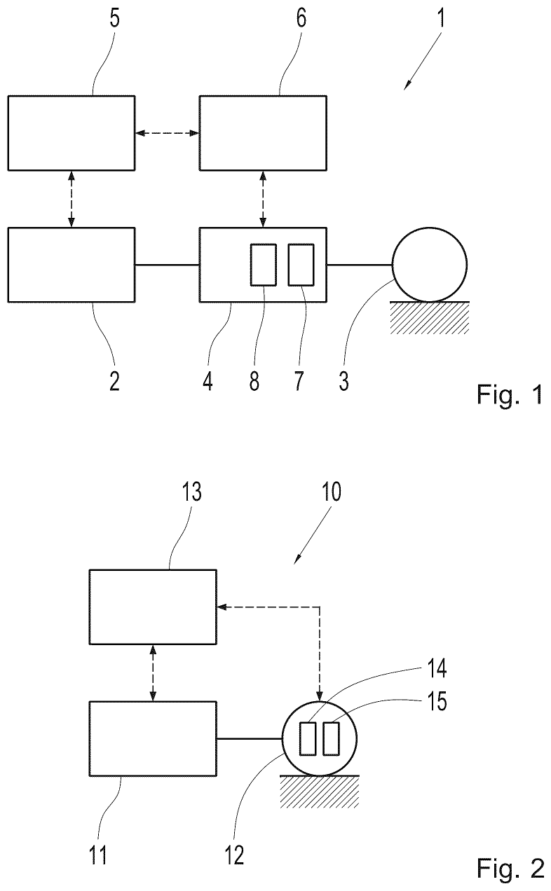

FIG. 1 shows, in a highly schematic manner, a diagram of an example drive train 1 of a motor vehicle, which is propelled solely by an internal combustion engine, or of a hybrid vehicle.

The drive train 1 shown in FIG. 1 includes a propulsion unit 2 and a transmission 4, the transmission 4 being connected between the propulsion unit 2 and a drive output 3. In a motor vehicle propelled by an internal combustion engine, the propulsion unit 2 is an internal combustion engine. In a hybrid vehicle, the propulsion unit 2 includes an electric machine.

FIG. 1 also shows an engine control unit 5 for the open-loop control and/or closed-loop control of the operation of the propulsion unit 2, and a transmission control unit 6 for the open-loop control and/or closed-loop control of the operation of the transmission 4.

The engine control unit 5 and the transmission control unit 6 are assemblies of a control system of the drive train 1.

FIG. 1 also shows, in a highly schematic manner, a parking lock 7 of the transmission 4, wherein a parking lock sensor 8 interacts with the parking lock 7. The parking lock sensor 8 monitors whether the parking lock 7 is engaged or disengaged and provides a corresponding measurement signal to the transmission control unit 6.

FIG. 2 shows a drive train 10 of an electric vehicle. The drive train 10 includes a propulsion unit 11, which is an electric machine which provides a drive torque at a driven end 12 of the drive train 10. The operation of the propulsion unit 11 is controlled in an open loop or a closed loop by an engine control unit 13.

A parking lock 14, with which a parking lock sensor 15 is associated, interacts with the driven end 12 of the electric vehicle shown in FIG. 2. The parking lock sensor 15 in turn monitors whether the parking lock 14 is engaged or disengaged. The parking lock sensor 15 in turn provides a corresponding measurement signal to the control unit 13.

Both in the drive train 1 shown in FIG. 1 and in the drive train 10 shown in FIG. 2, the respective parking lock sensor 8, 15 acquires a measurement signal and transmits the measurement signal to the respective control unit 6, 13.

The respective control unit 6, 13 receives the measurement signal transmitted from the respective parking lock sensor 8, 15, evaluates the measurement signal and, depending thereon, controls the operation of the respective drive train 1, 10 in an open loop and/or a closed loop.

According to the invention, the respective sensor, i.e., the parking lock sensor 8 in FIG. 1 and the parking lock sensor 15 in FIG. 2, transmits not only the measurement signal of the respective sensor, but also an actual identification signal for the respective sensor to the respective control unit 6, 13.

The respective control unit 6, 13 is configured to receive the actual identification signal transmitted from the respective sensor 8, 15, as well as the measurement signal of the respective sensor.

The respective control unit 6, 13 is configured to compare the actual identification signal transmitted from the respective sensor 8, 15 with a target identification signal for the respective sensor, which is stored in the respective control unit 6, 13.

The respective control unit 6, 13 controls, in an open loop and/or a closed loop, the operation of the respective drive train 1, 10 depending on the measurement signal received from the respective sensor 8, 15 only when the actual identification signal of the respective sensor 8, 15 corresponds to the target identification signal of the respective sensor 8, 15.

In this way, a digital coding is provided between the respective control unit 6, 13 and an assembly of the respective drive train 1, 10 that includes the respective sensor 8, 15. The actual identification signal is preferably a defined unique string of numbers. The target identification signal, which is stored in the respective control unit 6, 13, is then a defined unique string of numbers. Only when the actual identification signal matches the target identification signal does the version of the assembly that includes the respective sensor 8, 15 match the version of the respective control unit 6, 13, so that, only in this case, the respective control unit 6, 13 controls, in an open loop and/or a closed loop, the operation of the respective drive train 1, 11 depending on the signal received from the respective sensor 8, 15.

FIGS. 1 and 2 describe the invention using a parking lock sensor 8, 15 as an example. The invention is also usable in conjunction with a differential lock sensor, which monitors whether a differential lock of the drive train is engaged or disengaged.

Furthermore, the invention is usable in conjunction with a sensor which monitors whether a clutch is engaged or disengaged, which clutch can be an integral part of a disconnect unit, for example, in an electric axle.

In particular, the respective sensor 8, 15 uses a Single Edge Nibble Transmission protocol. Preferably, the respective sensor 8, 15 transmits the respective measurement signal of the respective sensor on a first channel, in particular on a fast channel, whereas the respective sensor 8, 15 transmits the actual identification signal of the respective sensor on a second channel, in particular on a slow channel.

The invention thus allows for a unique coding of a control-side assembly, specifically of a sensor, for a control unit of a drive train of the control system of a motor vehicle. To this end, a digital coding is used, which is provided by the sensor transmitting, in addition to the measurement signal of the sensor, an actual identification signal to the control unit, which the control unit compares with a target identification signal for the sensor, which is stored in the control unit. Only when the actual identification signal of the sensor matches the target identification signal for the sensor, which is stored in the control unit, is an operation of the drive train controlled, in an open loop and/or a closed loop, depending on the measurement signal provided by the sensor.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 drive train
2 propulsion unit
3 driven end
4 transmission
5 control unit
6 control unit
7 assembly
8 sensor
10 drive train
11 propulsion unit
12 driven end
13 control unit
14 assembly
15 sensor

1-10. (canceled)

11. A control system for operating a drive train (1, 10) of a motor vehicle, comprising:
at least one sensor (8, 15), each of the at least one sensor (8, 15) being configured to:
acquire a measurement signal for an assembly (7, 14) of the drive train (1, 10); and
transmit an actual identification signal for the respective sensor (8, 15); and
at least one control unit (6, 13), each of the at least one control unit (6, 13) being configured to:
receive the actual identification signal transmitted by a respective one of the at least one sensor (8, 15);
compare the actual identification signal with a target identification signal for the respective one of the at least one sensor (8, 15), the target identification signal being stored in the respective control unit (6, 13);
receive and evaluate the measurement signal from the respective one of the at least one sensor (8, 15); and
control the operation of the drive train (1, 10) in at least one of an open loop manner or a closed loop manner depending on the measurement signal only when the actual identification signal corresponds to the target identification signal for the respective one of the at least one sensor (8, 15).

12. The control system of claim 11, wherein the respective one of the at least one sensor (8, 15) transmits the measurement signal on a first channel, the first channel being a fast channel, and
wherein the respective one of the at least one sensor (8, 15) transmits the actual identification signal on a second channel, the second channel being a slow channel.

13. The control system of claim 12, wherein the respective one of the at least one sensor (8, 15) uses a Single Edge Nibble Transmission protocol to transmit the measurement signal and the actual identification signal.

14. The control system of claim 11, wherein the respective one of the at least one sensor (8, 15) is a Hall sensor.

15. The control system of claim 11, wherein one of the at least one sensor (8, 15) is a parking lock sensor, the parking lock sensor monitoring whether a parking lock of the drive train (1, 10) is engaged or disengaged, the measurement signal corresponding to whether the parking lock of the drive train (1, 10) is engaged or disengaged.

16. The control system of claim 11, wherein one of the at least one sensor (8, 15) is a differential lock sensor, the differential lock sensor monitoring whether a differential lock of the drive train (1, 10) is engaged or disengaged, the measurement signal corresponding to whether the differential lock of the drive train (1, 10) is engaged or disengaged.

17. The control system of claim 11, wherein one of the at least one sensor (8, 15) monitors whether a clutch of the drive train (1, 10) is engaged or disengaged, the measurement signal corresponding to whether the clutch of the drive train (1, 10) is engaged or disengaged.

18. The control system of claim 11, wherein the at least one control unit (6) comprises a transmission control unit of a transmission (4) of the motor vehicle or a control unit (13) of an electric axle of the motor vehicle.

19. A motor vehicle, comprising the control system claim 11.

20. The motor vehicle of claim 19, wherein the motor vehicle is an electric vehicle.
